(19) United States
(12) Patent Application Publication
(10) Pub. No.: US 2026/0163746 A1
(43) Pub. Date: Jun. 11, 2026

(54) COMPUTE PLATFORM AUTHENTICATION BY AN ELECTRONIC MODULE

(71) Applicant: HEWLETT PACKARD ENTERPRISE DEVELOPMENT LP, Spring, TX (US)

(72) Inventor: Melvin K. Benedict, Magnolia, TX (US)

(21) Appl. No.: 18/975,030

(22) Filed: Dec. 10, 2024

(51) Int. Cl. H04L 9/32; H04L 9/14

(52) U.S. Cl. CPC H04L 9/3263; H04L 9/14

(57) ABSTRACT

In some examples, an electronic module includes a nonvolatile memory storing a certificate chain of certificates, the certificates including an attribute certificate of the electronic module, where a public key is included in the attribute certificate. The electronic module includes a module controller to request a certificate from a processor in a compute platform in which the electronic module is placed, receive, from the processor in the compute platform, a signed version of the certificate as signed using a private key, and authenticate the compute platform by using the public key in the attribute certificate to decrypt the signed version of the certificate.

### BACKGROUND

A compute platform includes various electronic modules, such as processors, memory modules, input/output (I/O) devices, management controllers, and other electronic components. The compute platform can authenticate electronic modules placed in the compute platform before allowing the electronic modules to operate in the compute platform.

### BRIEF DESCRIPTION OF THE DRAWINGS

Some implementations of the present disclosure are described with respect to the following figures.

FIG. 1 is a block diagram of a compute platform including an electronic module according to some examples.

FIG. 2 is a block diagram of a host authentication certificate chain in the electronic module, according to some examples.

FIG. 3 is a flow diagram of a process performed by a security processor and an electronic module, according to some examples.

FIG. 4 and FIG. 5 are block diagrams of examples in which an electronic module is transferred to a transferee compute platform, according to some examples.

FIG. 6 is a block diagram of a system according to some examples.

FIG. 7 is a block diagram of a storage medium storing machine-readable instructions according to some examples.

FIG. 8 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Although authentication mechanisms may allow compute platforms to authenticate an electronic module before allowing the electronic module to operate in the compute platform, mechanisms may not be in place to allow the electronic module to authenticate the compute platform. In some cases, the compute platform may perform an update of the electronic module, such as to update machine-readable instructions of the electronic module, update configuration information of the electronic module, or other updates. However, an unauthorized update of the electronic module by the compute platform may cause the electronic module to malfunction or may allow an attacker to access content stored in the electronic module or leverage the electronic device to perform unauthorized operations in the compute platform. In an example, the electronic module may be removed from a first compute platform and placed in a second compute platform. Although the first compute platform may be authorized to update the electronic module, the second compute platform may not be authorized to do so. In another example, the compute platform in which the electronic module is provided may be infected with malware that may attempt to perform an unauthorized update of the electronic module.

In accordance with some implementations of the present disclosure, mechanisms are provided to allow an electronic module installed in a compute platform to authenticate the compute platform, based on use of a public key included in a certificate chain stored in a nonvolatile memory of the electronic module. A certificate chain includes a collection of certificates that are related to one another. During a cryptographic exchange between the electronic module and a security processor in the compute platform, the electronic module can request a certificate from the processor in the compute platform. In some examples, the requested certificate includes a platform certificate of the compute platform. The platform certificate includes a manifest of components in the compute platform. The security processor can include a cryptoprocessor (e.g., a trusted platform module (TPM)), a management controller (e.g., a baseboard management controller (BMC)), or any other management entity of the compute platform responsible for cryptographic or security operations of the compute platform. The electronic module receives, from the security processor in the compute platform as a response to the request, a signed version of the certificate, where the certificate was signed using a private key. The electronic module authenticates the compute platform by using the public key in the certificate chain to decrypt the signed version of the certificate. The public key and the private key are part of a public-private key pair. If the electronic module successfully authenticates the compute platform, the electronic module can enable the compute platform to update the electronic module, such as updating machine-readable instructions or configuration information in the electronic module.

A certificate (also referred to as a "digital certificate") includes a file or another object that is used to prove the authenticity of an entity based on the use of cryptography. A certificate contains specified information, such as a name or network address of an entity and/or other information.

A platform certificate can also be referred to as a manifest certificate. The platform certificate includes a manifest of components (e.g., a list of identifiers of the components, such as serial numbers, model information, etc.) in the compute platform as installed during the manufacture of the compute platform. In some examples, platform certificates are according to the Trusted Computing Group (TCG) Platform Certificate Profile Specification. A platform certificate is an X.509 attribute certificate signed by a certificate authority (CA) of a manufacturer of the compute platform.

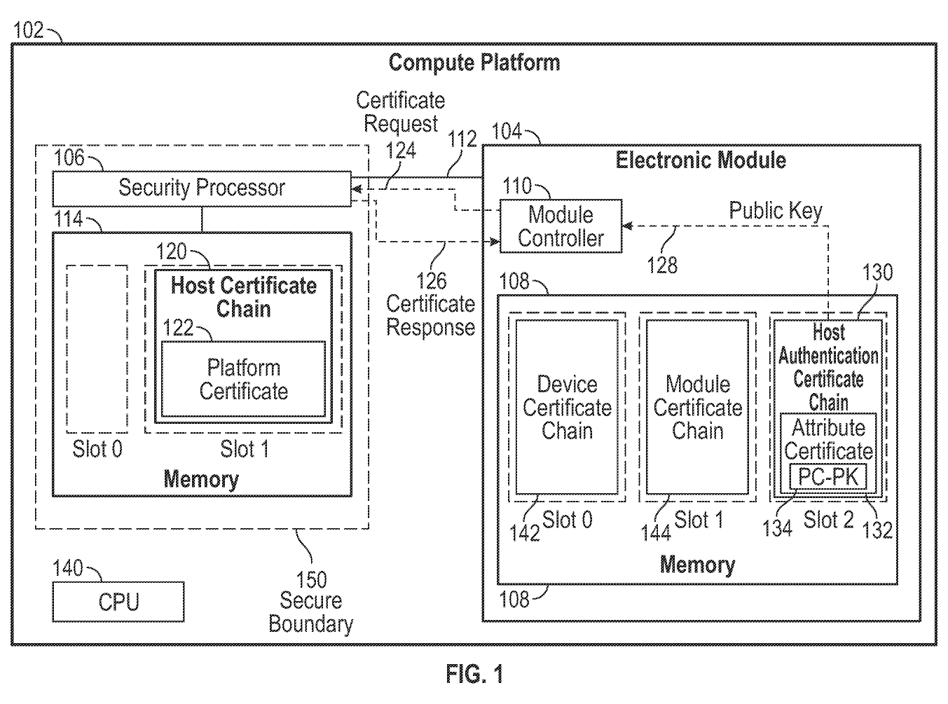

FIG. 1 is a block diagram of a compute platform 102, which can be implemented using one or more computers. The compute platform 102 includes an electronic module 104, which can include a circuit board or can be implemented using one or more packaged discrete components. In some examples, the electronic module 104 can include a memory module, such as a dual in-line memory module (DIMM) or another type of memory module. In further examples, the electronic module 104 can include a field replaceable unit (FRU) or any other type of electronic module. More generally, the electronic module 104 can include any assembly of electronic components. Although just one electronic module is depicted in FIG. 1, the compute platform 102 may include multiple electronic modules according to some examples of the present disclosure.

During manufacture of the compute platform 102, the electronic module 104 can be mounted in the compute platform 102, such as by mounting on a circuit board of the compute platform 102, or attaching to a connector in the compute platform 102. In some examples, the electronic module 104 is removably mounted in the compute platform 102 such that the electronic module 104 can be removed from the compute platform 102 after installation, and the electronic module 104 can be mounted in another compute platform.

The compute platform 102 further includes a security processor 106 that can authenticate the electronic module 104 (as well as other components in the compute platform 102). The security processor 106 can execute machine-readable instructions for performing security tasks in the compute platform 102. To authenticate the electronic module 104, the security processor 106 can validate information stored in a nonvolatile memory 108 of the electronic module 104 and validate components in the electronic module 104. The nonvolatile memory 108 can include a flash memory device, an electrically erasable and programmable read-only memory (EEPROM) device, or another type of nonvolatile memory device. A nonvolatile memory device is able to maintain its stored data even if power were removed from the memory device.

The electronic module 104 further includes a module controller 110 for performing various tasks of the electronic module 104. For example, if the electronic module 104 is a memory module, the module controller 110 can include a media controller that responds to commands from a memory controller (not shown) by asserting signals for accessing memory devices. If the electronic module 104 is an FRU, then the module controller 110 is an FRU controller.

A communication link 112 connects the security processor 106 and the electronic module 104. The communication link 112 can include a management link, such as an Inter-Integrated Circuit (I2C) bus, an Improved Inter-Integrated Circuit (I3C) bus, a Serial Peripheral Interface (SPI) bus, or any other type of management link. In some examples, a transport protocol such as a Management Component Transport Protocol (MCTP) can be used for messages exchanged over the communication link 112. MCTP is a protocol defined by the Distributed Management Task Force (DMTF) to support management-related communications between electronic components. In other examples, other types of protocols relating to management-related communications can be used, such as the Intelligent Platform Management Interface (IPMI) protocol, or another protocol.

In some examples, the authentication of the electronic module 104 by the security processor 106 can be according to the Security Protocols and Data Models (SPDM) standard promulgated by the DMTF’s SPDM Working group. The SPDM standard enables authentication, attestation, and key exchange to assist in providing infrastructure security.

In accordance with some implementations of the present disclosure, in addition to the security processor 106 of the compute platform 102 (the host of the electronic module 104) being able to authenticate the electronic module 104, the module controller of the electronic module 104 is also able to authenticate the compute platform 102 (the host) based on information of the compute platform 102. The information used by the module controller 110 to authenticate the compute platform 102 is a platform certificate 122 (or another certificate) that is part of a host certificate chain 120 stored in a nonvolatile memory 114 of the compute platform 102. In further examples, the module controller 110 can authenticate the compute platform using a secure device identification (DevID), as described in the Institute of Electrical and Electronics Engineers (IEEE) 802.1AR Secure Device Identity standard.

Using techniques or mechanisms according to some examples of the present disclosure, mutual authentication between the compute platform 102 (the host) and the electronic module 104 can be performed. Computer functionality is improved by ensuring that actions performed with respect to the electronic module 104 by the compute platform 102 are by an authenticated compute platform. For example, the mutual authentication can prevent an unauthorized update of the electronic module 104, which can cause errors or lead to malfunctions, allow unauthorized access of data, or unauthorized operations in the electronic module 104 and/or the compute platform 102.

The platform certificate 122 is signed using a private key, such as the private key of CA associated with the manufacturer of the compute platform 102. The signed platform certificate 122 includes a signature. A CA is a signing infrastructure that is used to generate cryptographic keys and sign certificates.

The module controller 10 sends a certificate request 124 to the security processor 106 over the communication link 112. In response to the certificate request 124, the security processor 106 accesses the host certificate chain 120 stored in the memory 114. The security processor 106 sends a certificate response 126 to the module controller 110. The certificate response 126 is responsive to the certificate request 124. The certificate response 126 can include either the entire host certificate chain 120 or a portion (less than the entirety) of the host certificate chain 120. For example, the certificate response can include just the platform certificate 122.

The module controller 110 retrieves (at 128) a platform certificate validation public key (PC-PK) 134 from a host authentication certificate chain 130 stored in the nonvolatile memory 108 of the electronic module 104. The PC-PK 134 is a public key for validating the platform certificate 122.

The module controller 110 uses the PC-PK 134 to validate the platform certificate 122 contained in the certificate response 126. If the platform certificate 122 is validated, then the module controller 110 has authenticated the compute platform 102. The module controller 110 can change a setting (referred to as an "update-enabled setting") in the module controller 110 to enable an entity in the compute platform 102, such as the security processor 106 or a central processing unit (CPU) 140 or another entity of the compute platform 102 to perform an update of the electronic module 104. For example, the entity in the compute platform 102 can update machine-readable instructions of the electronic module 104 or update configuration information in the electronic module 104.

The update-enabled setting of the module controller 110 can include a flag or another information element that can be set to one of several different values. If the update-enabled setting is set to a first value (e.g., "0"), then the module controller 110 would block any request to update the electronic module 104 received from a host, such as the compute platform 102 (or another compute platform). If the update-enabled setting is set to a different second value (e.g., "1"), then the module controller 110 allows a request to update the electronic module 104 received from a host, such as the compute platform 102 (or another compute platform).

The host authentication certificate chain 130 stored in the electronic module 104 includes a chain of certificates. The chain of certificates of the host authentication certificate chain includes an attribute certificate 132 that contains the PC-PK 134 used for validating the platform certificate 122 from the compute platform 102.

An attribute certificate is also referred to as a module certificate. An attribute certificate is used to store a list of attributes. Thus, the attribute certificate 132 in the electronic module 104 contains attribute(s) for the electronic module 104. In some examples of the present disclosure, an attribute in the attribute certificate 132 is the PC-PK 134. The PC-PK 134 is part of a public-private key pair that further includes the private key (e.g., CA private key) used by the CA of the manufacturer of the compute platform 102 to sign the platform certificate 122.

In some examples according to SPDM, certificate chains can be stored in certificate slots, which are logical locations for containing respective certificate chains. Each certificate slot can be empty or may contain a certificate chain. In the example of FIG. 1, the electronic module 104 includes slots 0, 1, and 2, and the compute platform 102 includes slots 0 and 1. In other examples, a different quantity of certificate slots for certificate chains may be present in the electronic module 104 or the compute platform 102. Any certificate chain in a certificate slot is stored in a respective nonvolatile memory (e.g., 108 or 114).

In the electronic module 104, slot 0 contains a device certificate chain 142, slot 1 contains a module certificate chain 144, and slot 2 contains the host authentication certificate chain 130. Although FIG. 1 shows the host authentication certificate chain 130 as contained in slot 2, in other examples, the host authentication certificate chain 130 may be contained in a different slot.

The module certificate chain 144 can include an attribute certificate (not shown) that contains a golden measurement value(s) derived by applying a function (e.g., a cryptographic hash function) on information (e.g., machine-readable instructions and/or configuration information) in the electronic module 104. The golden measurement value(s) in the attribute certificate of the module certificate chain 144 can be used by the security processor 106 for authenticating the electronic module 104. The device certificate chain 142 includes a device certificate (not shown), which is also referred to as a leaf certificate. The device certificate may be used to store public and private keys of the electronic module 104.

The host authentication certificate chain 130 is different from the module certificate chain 144 and the device certificate chain 142. The host authentication certificate chain 130 is provided in the electronic module 104 to enable the module controller 110 to authenticate the compute platform 102 in which the electronic module 104 is installed. The term "host authentication certificate chain" is to indicate that the certificate chain is for validating a host in which the electronic module 104 is located

The compute platform 102 can similarly include multiple certificate slots, including slot 0 and slot 1, for storing respective certificate chains in the nonvolatile memory 114 of the compute platform 102. In the example of FIG. 1, the host certificate chain 120 containing the platform certificate 122 is contained in slot 1 of the compute platform 102. Slot 0 of the compute platform 102 is empty. In other examples, slot 0 of the compute platform 102 may contain a certificate chain.

The security processor 106 and the nonvolatile memory 114 can be included within a secure boundary 150 (also referred to as a "secure enclave") of the compute platform 102. The secure boundary 150 defines a compute platform section containing components that are secured against unauthorized access. The secure boundary 150 can be implemented based on physical isolation from entities in the compute platform 102 that are not authorized to access components in the security boundary 150. Alternatively or additionally, the secure boundary 150 can be implemented using security mechanisms to enforce what entities are able to interact with the components in the security boundary 150.

The CPU 140 is separate from the security processor 106. The CPU 140 executes primary machine-readable instructions of the compute platform 102, such as an operating system (OS), system firmware, and application programs. The system firmware can include Basic Input/Output System (BIOS) code or Universal Extensible Firmware Interface (UEFI) code. The CPU 140 can include one or more hardware processors. The primary machine-readable instructions are separate and distinct from the machine-readable instructions executed by the security processor 106.

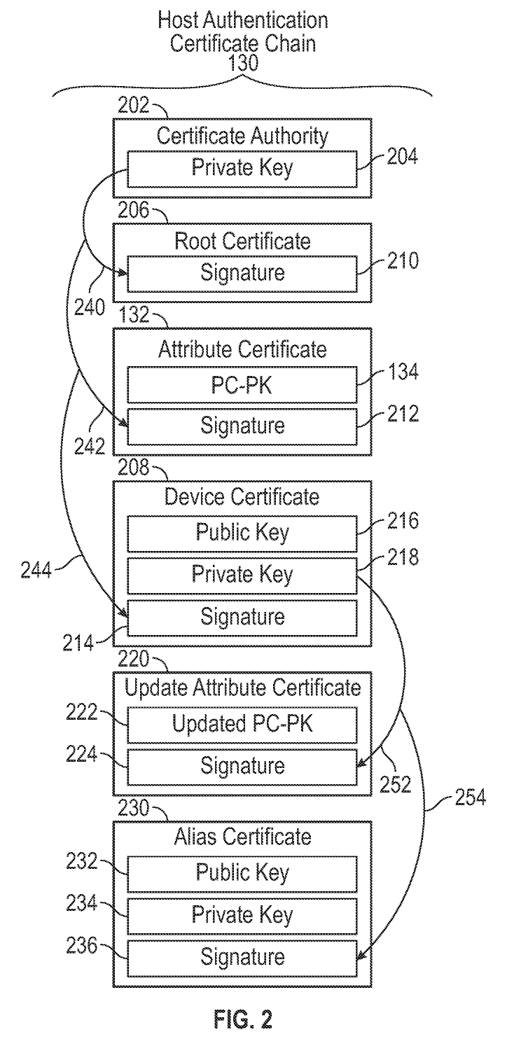

FIG. 2 is a block diagram of an example of the host authentication certificate chain 130. In other examples, the host authentication certificate chain 130 can include a different arrangement of certificates.

The root of the host authentication certificate chain 130 is a CA 202, which is the trust anchor for the host authentication certificate chain 130. The CA may be associated with the manufacturer of the electronic module 104 or another party. The CA 202 contains a CA private key 204.

The CA private key 204 is used to sign (at 240, 242, 244) a root certificate 206, the attribute certificate 132, and a device certificate 208. The signing (at 240) of the root certificate 206 produces a root certificate signature 210 that is part of the root certificate 206, the signing (at 242) of the attribute certificate 132 produces an attribute certificate signature 212 that is part of the attribute certificate 132, and the signing (at 244) of the device certificate 208 produces a device certificate signature 214 that is part of the device certificate 208. The signing of the attribute certificate 132 and the device certificate 208 by the CA 202 establishes trust of the attribute certificate 132 and the device certificate 208.

The attribute certificate 132 includes an attribute list, which contains one or more attributes. In some examples, an attribute in the attribute certificate 132 is the PC-PK 134. The attribute certificate 132 may contain other attributes including further information of the electronic module 104.

The device certificate 208 includes a public key 216 and a private key 218 of the electronic module 104. The public key 216 and the private key 218 form a public-private key pair of the electronic module 104.

In some examples, it may be possible to physically transfer the electronic module 104 from the compute platform 102 to another compute platform (referred to as a "transferee" compute platform). In some examples, to support the electronic module 104's ability to authenticate the transferee compute platform using the host authentication certificate chain 130, a management entity (e.g., the security processor 106 or another management entity) in the compute platform 102 can generate an update (delta) attribute certificate 220 that includes an attribute list containing one or more updated attributes. An updated attribute contained in the update attribute certificate 220 is an updated PC-PK 222 for validating a signed platform certificate from the transferee compute platform. The update attribute certificate 220 can be signed (at 252) using the private key 218 of the device certificate 208, which generates an update attribute certificate signature 224 in the update attribute certificate 220.

Along with the generation of the update attribute certificate 220, the management entity can also create an alias certificate 230, which is an updated version of the device certificate 208. Note that the update attribute certificate 220 and the alias certificate 230 are both part of the host authentication certificate chain 130.

The alias certificate 230 includes a public key 232 and a private key 234 (which form a public-private key pair). The alias certificate 230 is signed (at 254) with the private key 218 of the device certificate 208, which produces an alias certificate signature 236 that is part of the alias certificate 230.

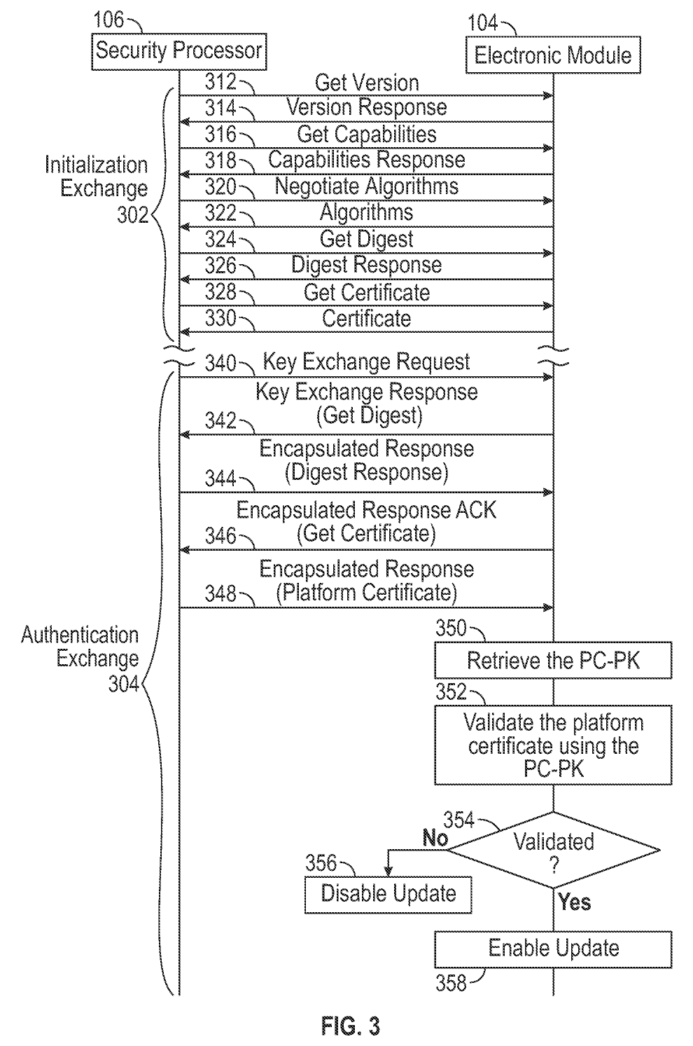

FIG. 3 is a flow diagram of a process performed by the security processor 106 and the electronic module 104 to support the authentication of the host (the compute platform 102) by the electronic module 104. The process of FIG. 3 can be referred to as an "authentication exchange" in which the security processor 106 has a role of a requester and the electronic module 104 has a role of a responder.

A requester is an entity that initiates the authentication exchange, and the responder is an entity that responds to a request from the requester. According to the SPDM standard, an entity has a role of a requester if the entity is the source of an SPDM request message, and an entity has a role of a responder if the entity receives an SPDM request message.

In some examples, the process of FIG. 3 may be performed after each power cycle of the compute platform 102, or more generally, when the compute platform 102 starts from a disabled state (e.g., power off state, low power state, or any other state in which the compute platform 102 is not operational). Messages exchanged in FIG. 3 may be according to the SPDM standard and may be transferred over the communications link 112 of FIG. 1 using the MCTP transfer protocol, for example.

The process of FIG. 3 includes an initialization exchange 302 and a host authentication exchange 304. The initialization exchange 302 includes an exchange of messages that sets up the ability of the security processor 106 to authenticate the electronic module 104. The host authentication exchange 304 includes an exchange of messages in which the electronic module 104 authenticates the host (the compute platform 102). Although FIG. 3 shows each the initialization exchange 302 and the host authentication exchange 304 as including specific example messages, in other examples, the initialization exchange 302 and the host authentication exchange 304 can include other messages.

The initialization exchange 302 includes the security processor 106 sending (at 312) a Get Version request to the electronic module 104. The Get Version request is a request for version information of information in the electronic module 104 that is to be validated by the security processor 106. The version information allows the security processor 106 to determine what version of information is stored in the electronic module 104. The module controller 110 in the electronic module 104 retrieves the version information from the nonvolatile memory 108. The electronic module 104 sends (at 314) a Version Response containing the version information to the security processor 106.

In the initialization exchange 302, the security processor 106 also sends (at 316) a Get Capabilities request to the electronic module 104, to seek information of capabilities supported by the electronic module 104. The capabilities can include the hashing algorithm(s) supported by the electronic module 104, and the signature algorithm(s) supported by the electronic module 104. A hashing algorithm can be used to measure information of the electronic module 104. A signature algorithm can be used to generate a signature.

The module controller 110 in the electronic module 104 retrieves the capabilities information from the nonvolatile memory 108, and sends (at 318) a Capabilities Response containing the capabilities information to the security processor 106. In some examples, the capabilities information may indicate that the electronic module 104 supports multiple hash algorithms and/or signature algorithms. In such examples, the security processor 106 can negotiate an algorithm to use with the electronic module 104.

The security processor 106 sends (at 320) a Negotiate Algorithms request to the electronic module 104. If the electronic module 104 supports multiple hash algorithms, then the security processor 106 can select a hash algorithm from among the multiple hash algorithms and include the selected hash algorithm in the Negotiate Algorithms request. Similarly, if the electronic module 104 supports multiple signature algorithms, then the security processor 106 can select a signature algorithm from among the multiple signature algorithms and include the selected signature algorithm in the Negotiate Algorithms request.

In response to the Negotiate Algorithms request, the electronic module 104 sends (at 322) an Algorithms response to the security processor 106, where the Algorithms response includes information of the selected hash algorithm and/or the selected signature algorithm.

The security processor 106 further sends (at 324) a Get Digest request to the electronic module 104. In response, the electronic module 104 sends (at 326) a Digest Response that identifies what certificate slots contain certificate chains in the electronic module 104. The security processor 106 further sends (at 328) a Get Certificate request to the electronic module 104, to obtain the module certificate chain 144 in a selected slot (e.g., slot 1 in FIG. 1) of the electronic module 104. In response, the electronic module 104 sends (at 330) the requested certificate to the security processor 106, which can use at least a portion of the module certificate chain 144 (including the attribute certificate containing a golden measurement value(s)) for authentication of the electronic module 104 based on further information obtained from the electronic module 104 (not shown). For example, further exchanges of messages (not shown) between the security processor 106 and the electronic module 104 involves the security processor 106 obtaining a measurement (or measurements) from the electronic module 104 for comparison to the golden measurement value(s). The further exchanges of messages can also include the security processor 106 issuing a challenge to the electronic module 104 and the electronic module 104 responding with a challenge response. The comparison of measurement(s) and the challenge-response exchange are used by the security processor 106 to authenticate the electronic module 104.

In the host authentication exchange 304, the security processor 106 sends (at 340) a Key Exchange request to the electronic module 104. The Key Exchange request is used to initiate a session to perform a cryptographic exchange of cryptographic parameters between the security processor 106 and the electronic module 104.

In response to the Key Exchange Request, the electronic module 104 sends (at 342) a Key Exchange Response. A Get Digest request is encapsulated in the Key Exchange Response. This Get Digest request is referred to as an encapsulated Get Digest request. Note that when performing mutual authentication, the responder (which in this case is the electronic module 104) of the authentication exchange also issues request messages to the requester (which in this case is the security processor 106). Message encapsulation preserves the roles of requester and responder in the authentication exchange, while allowing the responder to issue request messages to allow the responder to authenticate the requester (the electronic module 104 authenticating the compute platform 102).

The security processor 106 responds to the encapsulated Get Digest request by sending (at 344) an Encapsulated Response that encapsulates the Digest Response. The Digest Response contains information of certificate slots in the compute platform 102, including slot 1 of the compute platform 102 that contains the host certificate chain 120 of FIG. 1. Based on information of the certificate slots in the Digest Response, the module controller 110 in the electronic module 104 selects a certificate slot from which to request a certificate chain. The selection of which certificate slot to use can be based on preconfigured information in the electronic module 104 (e.g., at the time the electronic module is installed in the compute platform 102) identifying which slot contains the host certificate chain 120.

The electronic module 104 sends (at 346) an Encapsulated Response Ack that encapsulates a Get Certificate request. The Get Certificate request is to request the host certificate chain 120.

In response to the Get Certificate request, the security processor 106 sends (at 348) an Encapsulated Response that contains at least a portion of the host certificate chain 120. The portion of the host certificate chain 120 included in the Encapsulated Response sent (at 348) includes the platform certificate 122, which is signed.

At this point, the module controller 110 can retrieve (at 350) the PC-PK 134 from the attribute certificate 132 in the host authentication certificate chain 130 stored in the electronic module 104. The module controller 110 uses the PC-PK 134 to validate (at 352) the signed platform certificate 122. For example, the module controller 110 can decrypt the signature of the signed platform certificate 122, which recovers a nonce that is compared by the module controller 110 to an expected nonce to determine whether the signed platform certificate 122 is valid. The expected nonce is an arbitrary value (e.g., a random number or a pseudo-random number) that is used once as part of a cryptographic operation.

The module controller 110 determines (at 354) whether the signed platform certificate 122 has been validated. If not, the module controller 110 disables (at 356) the electronic module 104 from being updated by the compute platform 102. If the signed platform certificate 122 has been validated, the module controller 110 enables (at 358) an update of the electronic module 104 by the compute platform 102.

Although not shown in FIG. 3, the host authentication exchange 304 includes further exchanges of messages between the security processor 106 and the electronic module 104 to complete the host authentication exchange 304.

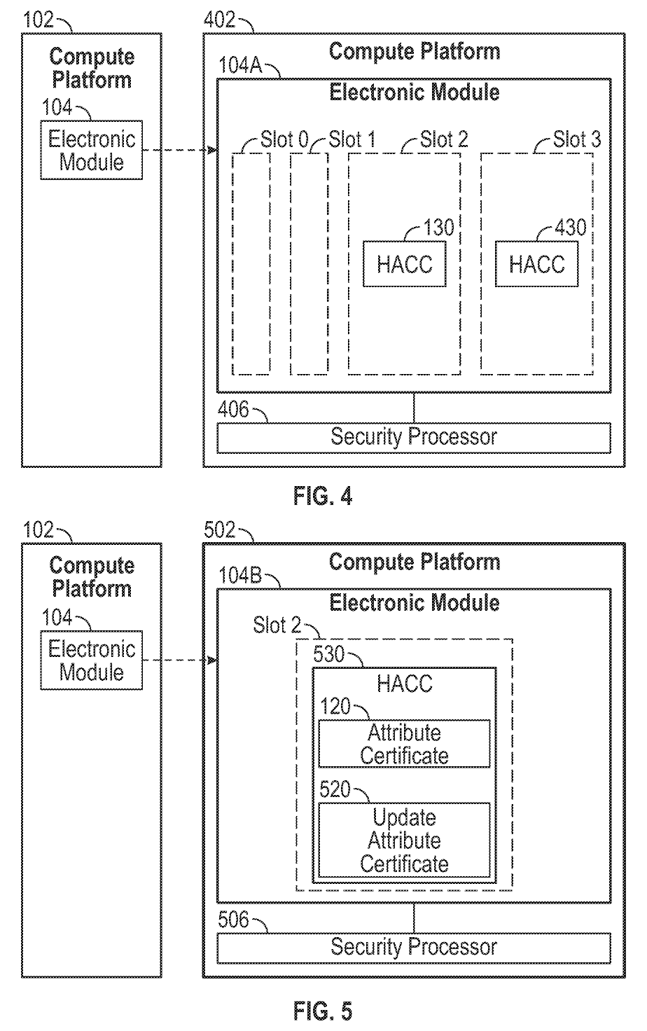

As noted above, it is possible to transfer the electronic module 104 from the compute platform 102 to a transferee compute platform that is different from the compute platform 102. FIG. 4 shows a transfer of the electronic module 104 from the compute platform 102 to a transferee compute platform 402. After the transfer, the electronic module is referenced as 104A.

In the example of FIG. 4, as part of the transfer, a management entity in the transferee compute platform 402 (such as a security processor 406) can revoke the host authentication certificate chain 130 (abbreviated "HACC" in FIG. 4) in slot 2 in the electronic module 104A. The management entity can write a new HACC 430 to another slot, such as slot 3 in the electronic module 104A. The new HACC 430 includes an attribute certificate that includes a new PC-PK that can be used to validate a platform certificate of the transferee compute platform 402. In this way, the electronic module 104A can authenticate the transferee compute platform 402.

In alternative examples, instead of adding the new HACC 430 to slot 3 (or another slot different from slot 2), the management entity in the transferee compute platform 402 can delete the HACC 130 from slot 2, and replace the deleted HACC 130 with the new HACC 430 in slot 2.

FIG. 5 shows a transfer of the electronic module 104 from the compute platform 102 to a transferee compute platform 502. After the transfer, the electronic module is referenced as 104B. In the example of FIG. 5, as part of the transfer, a management entity in the transferee compute platform 502 (such as a security processor 506) can update the HACC in slot 2 by adding an update attribute certificate 520 (similar to the update attribute certificate 220 of FIG. 2) to the HACC. The updated HACC is depicted to as updated HACC 530.

After the transfer, the electronic module 104B can use the updated PC-PK in the update attribute certificate 520 to validate a platform certificate from the compute platform 502. In this way, the electronic module 104B can authenticate the transferee compute platform 502.

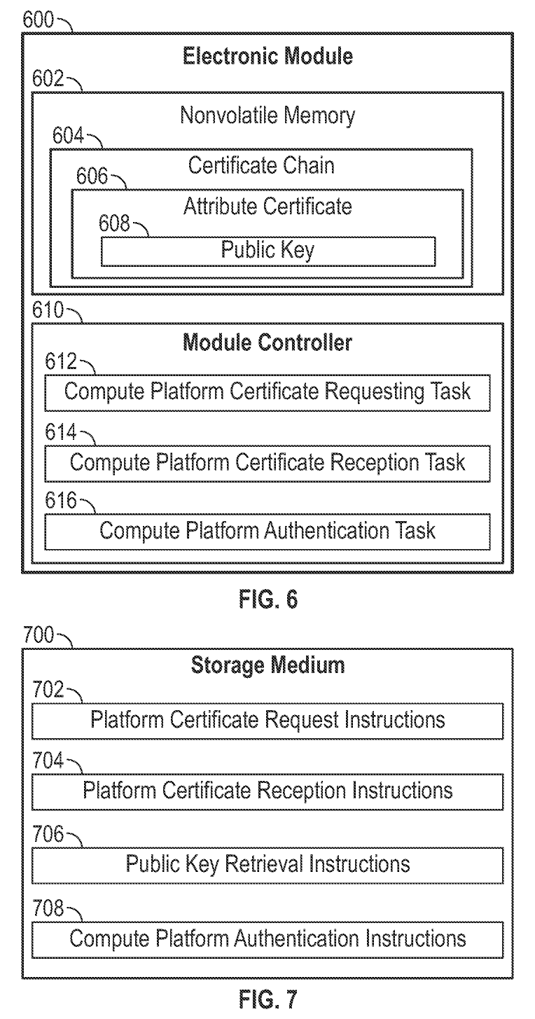

FIG. 6 is a block diagram of an electronic module 600 according to some examples of the present disclosure. An example of the electronic module 600 is the electronic module 104 of FIG. 1.

The electronic module 600 includes a nonvolatile memory 602 storing a certificate chain of certificates 604, the certificates including an attribute certificate 606 of the electronic module. A public key 608 is included in the attribute certificate 606. An example of the public key 608 is the PC-PK 134 of FIG. 1.

The electronic module 600 includes a module controller 610 to perform various tasks of the electronic module 600. As used here, a "controller" can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a "controller" can refer to a combination of one or more hardware processing circuits and machine-readable instructions (software and firmware) executable on the one or more hardware processing circuits.

The tasks of the module controller 610 include a compute platform certificate requesting task 612 to request a certificate from a processor in a compute platform in which the electronic module 600 is placed. An example of the processor is the security processor 106 of FIG. 1. An example of the requested certificate is the platform certificate 122 of FIG. 1.

The tasks of the module controller 610 include a compute platform certificate reception task 614 to receive, from the processor in the compute platform, a signed version of the certificate as signed using a private key. The signed version of the certificate includes a signature.

The tasks of the module controller 610 include a compute platform authentication task 616 to authenticate the compute platform by using the public key in the attribute certificate to decrypt the signed version of the certificate. More specifically, the signature of the certificate is decrypted to determine whether the certificate is valid.

In some examples, the module controller 610 sends a certificate information request to the processor to obtain location information of a certificate chain containing the certificate in the compute platform. The certificate information request can include a Get Digest request according to the SPDM standard, for example. The location information can identify a certificate slot containing a certificate chain. The certificate is requested by the module controller 610 using the location information.

In some examples, the module controller 610 receives information identifying logical locations (e.g., certificate slots) in the compute platform containing certificate chains. The module controller 610 selects, from the logical locations, a logical location (e.g., slot 1 in the compute platform 102 of FIG. 1) from which the certificate is requested.

In some examples, the module controller 610 receives, from the processor in the compute platform, an indication to initiate a cryptographic exchange. The indication can be a Key Exchange Request according to the SPDM standard, for example. The module controller 610 requests the certificate from the processor in the compute platform in response to the indication.

In some examples, the certificate chain 604 is installed in the nonvolatile memory as part of a manufacturing the compute platform in which the electronic module is mounted.

In some examples, the module controller 610 enables an update of the electronic module by the compute platform based on authenticating the compute platform.

In some examples, the compute platform is a first compute platform. As part of transferring the electronic module 600 from the first compute platform to a second compute platform, the module controller 610 revokes the certificate chain 604 in a first logical location (e.g., a first slot such as slot 2 in FIG. 4) of the electronic module 600 and writes a new certificate chain in a second logical location (e.g., a second slot such as slot 3 in FIG. 4). The new certificate chain includes a new public key for validating a certificate from the second compute platform. The revocation of the certificate chain 604 and the addition of the new certificate chain can be in response to requests from a management entity (e.g., a security processor) in the second compute platform.

In some examples, as part of transferring the electronic module 600 from the first compute platform to the second compute platform, the module controller 610 erases the certificate chain 604 from the nonvolatile memory 602 and writes a new certificate chain in place of the erased certificate chain 604 in the same slot. The new certificate chain includes a new public key for validating a certificate from the second compute platform. The erasing of the certificate chain 604 and the addition of the new certificate chain can be in response to requests from a management entity (e.g., a security processor) in the second compute platform.

In some examples, as part of transferring the electronic module from the first compute platform to a second compute platform, the module controller 610 adds an update attribute certificate to the certificate chain 604, the update attribute certificate including a new public key for validating a certificate from the second compute platform. The addition of the update attribute certificate to the certificate chain 604 can be in response to a request from a management entity (e.g., a security processor) in the second compute platform.

In some examples, as part of transferring the electronic module from the first compute platform to the second compute platform, the module controller 610 further adds an alias certificate to the certificate chain 604. The alias certificate includes a public key and a private key of the electronic module. The addition of the alias certificate to the certificate chain 604 can be in response to a request from a management entity (e.g., a security processor) in the second compute platform.

In some examples, the module controller 610 requests the certificate from the processor by sending an encapsulated request for the certificate, the encapsulated request included in a message sent by the electronic module. The processor has a role of a requester and the electronic module has a role of a responder in an authentication exchange between the processor and the electronic module.

In some examples, the signed version of the certificate is received at the electronic module in an encapsulated response sent by the processor in the role of the requester.

FIG. 7 is a block diagram of a non-transitory machine-readable or computer-readable storage medium 700 storing machine-readable instructions that upon execution cause an electronic module to perform various tasks. The electronic module may be the electronic module 104 of FIG. 1, for example.

The machine-readable instructions include platform certificate request instructions 702 to request a platform certificate from a security processor in a compute platform in which the electronic module is placed. The platform certificate includes a manifest of components in the compute platform.

The machine-readable instructions include platform certificate reception instructions 704 to receive, from the security processor in the compute platform, a signed version of the platform certificate as signed using a private key. The private key is part of a public-private key pair.

The machine-readable instructions include public key retrieval instructions 706 to retrieve, from a nonvolatile memory of the electronic module, a public key from a host authentication certificate chain. The public key is part of the public-private key pair. An example of the public key is the PC-PK 134 of FIG. 1.

The machine-readable instructions include compute platform authentication instructions 708 to authenticate, by the electronic module, the compute platform by validating the signed version of the platform certificate using the public key in the host authentication certificate chain.

In some examples, the request for the platform certificate and the platform certificate are included in respective encapsulated messages between the electronic module and the security processor with the security processor having a role of a requester and the electronic module having a role of a responder in an authentication exchange between the security processor and the electronic module.

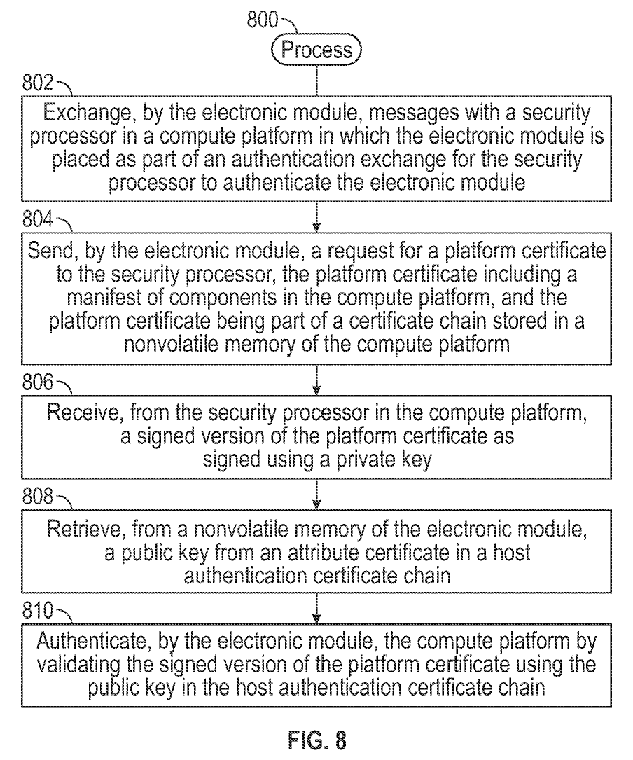

FIG. 8 is a flow diagram of a process 800, which may be performed by the electronic module 104 of FIG. 1, for example. The process 800 includes exchanging (at 802), by the electronic module, messages with a security processor in a compute platform in which the electronic module is placed as part of an authentication exchange for the security processor to authenticate the electronic module. The messages exchanged can include the messages of the initialization exchange 302 of FIG. 3, for example.

The process 800 includes sending (at 804), by the electronic module, a request for a platform certificate to the security processor, the platform certificate including a manifest of components in the compute platform, and the platform certificate being part of a certificate chain stored in a nonvolatile memory of the compute platform. An example of the certificate chain in the compute platform is the host certificate chain 120 of FIG. 1.

The process 800 includes receiving (at 806), from the security processor in the compute platform, a signed version of the platform certificate as signed using a private key. The signed version of the platform certificate is received over a communication link between the electronic module and the security processor.

The process 800 includes retrieving (at 808), from a nonvolatile memory of the electronic module, a public key from an attribute certificate in a host authentication certificate chain. An example of the host authentication certificate chain is the host authentication certificate chain 130 of FIG. 1.

The process 800 includes authenticating (at 810), by the electronic module, the compute platform by validating the signed version of the platform certificate using the public key in the host authentication certificate chain.

Various figures(e.g., FIGS. 3 and 8) that show processes include specific orders of tasks. In other examples, the tasks of a process can be performed in a different order, some tasks may be omitted, and other tasks can be added.

A "BMC" that is an example of the security processor 106 of FIG. 1 can refer to a specialized service controller that monitors the physical state of a compute platform using sensors and communicates with a remote management system (that is remote from the compute platform) through an independent "out-of-band" connection. The BMC can perform management tasks to manage components of the compute platform. Examples of management tasks that can be performed by the BMC can include any or some combination of the following: power control to perform power management of the compute platform (such as to transition the compute platform between different power consumption states in response to detected events), thermal monitoring and control of the compute platform (such as to monitor temperatures of the compute platform and to control thermal management states of the compute platform), fan control of fans in the compute platform, system health monitoring based on monitoring measurement data from various sensors of the compute platform, remote access of the compute platform (to access the compute platform over a network, for example), remote reboot of the compute platform (to trigger the compute platform to reboot using a remote command), system setup and deployment of the compute platform, system security to implement security procedures in the compute platform, and so forth.

In some examples, the BMC can provide so-called "lights-out" functionality for a compute platform. The lights out functionality may allow a user, such as a systems administrator, to perform management operations on the compute platform even if an OS is not installed or not functional on the compute platform.

Moreover, in some examples, the BMC can run on auxiliary power provided by an auxiliary power supply (e.g., a battery); as a result, the compute platform does not have to be powered on to allow the BMC to perform the BMC's operations. The auxiliary power supply is separate from a main power supply that supplies powers to other components (e.g., a main processor, a memory, an input/output (I/O) device, etc.) of the compute platform.

A CPU can include one or more hardware processors. A hardware processor can include a microprocessor, a core of a multi-core microprocessor, a microcontroller, a programmable integrated circuit, a programmable gate array, or another hardware processing circuit.

A storage medium (e.g., 700 in FIG. 7) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term "a," "an," or "the" is intended to include the plural forms as well, unless the context clearly indicates otherwise. Also, the term "includes," "including," "comprises," "comprising," "have," or "having" when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An electronic module comprising:
a nonvolatile memory storing a certificate chain of certificates, the certificates comprising an attribute certificate of the electronic module, wherein a public key is included in the attribute certificate; and
a module controller to:
request a certificate from a processor in a compute platform in which the electronic module is placed;
receive, from the processor in the compute platform, a signed version of the certificate as signed using a private key; and
authenticate the compute platform by using the public key in the attribute certificate to decrypt the signed version of the certificate.

2. The electronic module of claim 1, wherein the certificate comprises a platform certificate including a manifest of components in the compute platform, and wherein the signed version of the certificate comprises a signed version of the platform certificate, and the public key from the attribute certificate is used to validate the signed version of the platform certificate for authenticating the compute platform by the electronic module.

3. The electronic module of claim 1, wherein the module controller is to:
send a certificate information request to the processor to obtain location information of a certificate chain containing the certificate in the compute platform,
wherein the certificate is requested by the module controller using the location information.

4. The electronic module of claim 3, wherein the module controller is to:
receive information identifying logical locations in the compute platform containing certificate chains; and
select, from the logical locations, a logical location from which the certificate is requested.

5. The electronic module of claim 1, wherein the module controller is to:
receive, from the processor in the compute platform, an indication to initiate a cryptographic exchange; and
request the certificate from the processor in the compute platform in response to the indication.

6. The electronic module of claim 1, wherein the certificate chain of certificates is installed in the nonvolatile memory as part of a manufacturing the compute platform in which the electronic module is mounted.

7. The electronic module of claim 1, wherein the module controller is to:
enable an update of the electronic module by the compute platform based on authenticating the compute platform.

8. The electronic module of claim 1, wherein the compute platform is a first compute platform, and wherein the module controller is to:
as part of transferring the electronic module from the first compute platform to a second compute platform, revoke the certificate chain in a first logical location of the electronic module and write a new certificate chain in a second logical location, the new certificate chain comprising a new public key for validating a certificate from the second compute platform.

9. The electronic module of claim 1, wherein the compute platform is a first compute platform, and wherein the module controller is to:
as part of transferring the electronic module from the first compute platform to a second compute platform, erase the certificate chain from the nonvolatile memory and write a new certificate chain in place of the erased certificate chain, the new certificate chain comprising a new public key for validating a certificate from the second compute platform.

10. The electronic module of claim 1, wherein the compute platform is a first compute platform, and wherein the module controller is to:
as part of transferring the electronic module from the first compute platform to a second compute platform, add an update attribute certificate to the certificate chain, the update attribute certificate comprising a new public key for validating a certificate from the second compute platform.

11. The electronic module of claim 10, wherein the module controller is to:
as part of transferring the electronic module from the first compute platform to the second compute platform, further add an alias certificate to the certificate chain, the alias certificate comprising a public key and a private key of the electronic module.

12. The electronic module of claim 1, wherein the module controller to request the certificate from the processor by sending an encapsulated request for the certificate, the encapsulated request included in a message sent by the electronic module, wherein the processor has a role of a requester and the electronic module has a role of a responder in an authentication exchange between the processor and the electronic module.

13. The electronic module of claim 12, wherein the signed version of the certificate is received at the electronic module in an encapsulated response sent by the processor in the role of the requester.

14. A non-transitory machine-readable storage medium comprising instructions that upon execution cause an electronic module to:
request a platform certificate from a security processor in a compute platform in which the electronic module is placed, the platform certificate including a manifest of components in the compute platform;
receive, from the security processor in the compute platform, a signed version of the platform certificate as signed using a private key;
retrieve, from a nonvolatile memory of the electronic module, a public key from a host authentication certificate chain; and
authenticate, by the electronic module, the compute platform by validating the signed version of the platform certificate using the public key in the host authentication certificate chain.

15. The non-transitory machine-readable storage medium of claim 14, wherein the public key is in an attribute certificate of the host authentication certificate chain.

16. The non-transitory machine-readable storage medium of claim 14, wherein the compute platform is a first compute platform, and wherein the instructions upon execution cause the electronic module to:
as part of transferring the electronic module from the first compute platform to a second compute platform:
revoke the certificate chain in a first logical location of the electronic module and write a new certificate chain in a second logical location, the new certificate chain comprising a new public key for validating a platform certificate from the second compute platform, or
erase the certificate chain from the nonvolatile memory and write a new certificate chain in place of the erased certificate chain, the new certificate chain comprising a new public key for validating the platform certificate from the second compute platform.

17. The non-transitory machine-readable storage medium of claim 14, wherein the compute platform is a first compute platform, and wherein the instructions upon execution cause the electronic module to:
as part of transferring the electronic module from the first compute platform to a second compute platform, add an update attribute certificate to the certificate chain, the update attribute certificate comprising a new public key for validating the platform certificate from the second compute platform.

18. The non-transitory machine-readable storage medium of claim 14, wherein the request for the platform certificate and the platform certificate are included in respective encapsulated messages between the electronic module and the security processor with the security processor having a role of a requester and the electronic module having a role of a responder in an authentication exchange between the security processor and the electronic module.

19. A method comprising:
exchanging, by an electronic module, messages with a security processor in a compute platform in which the electronic module is placed as part of an authentication exchange for the security processor to authenticate the electronic module;
sending, by the electronic module, a request for a platform certificate to the security processor, the platform certificate including a manifest of components in the compute platform, and the platform certificate being part of a certificate chain stored in a nonvolatile memory of the compute platform;
receiving, from the security processor in the compute platform, a signed version of the platform certificate as signed using a private key;
retrieving, from a nonvolatile memory of the electronic module, a public key from an attribute certificate in a host authentication certificate chain; and
authenticating, by the electronic module, the compute platform by validating the signed version of the platform certificate using the public key in the host authentication certificate chain.

20. The method of claim 19, wherein the validating of the signed version of the platform certificate comprises decrypting a signature of the signed version of the platform certificate using the public key in the host authentication certificate chain.
